(19) United States
(12) Patent Application Publication
(10) Pub. No.: US 2004/0062650 A1
(43) Pub. Date: Apr. 1, 2004

(54) Cast wheel and hub for a torque converter

(75) Inventors: Shriraj K. Makim, Novi, MI (US); Michael Alan Brockway, Pinckney, MI (US); Teng-Hua Shieh, Ann Arbor, MI (US)

Correspondence Address: MACMILLAN, SOBANSKI & TODD, LLC, ONE MARITIME PLAZA - FOURTH FLOOR, 720 WATER STREET, TOLEDO, OH, 43604, US

(73) Assignee: Ford Global Technologies, Inc., Dearborn, MI (US)

(21) Appl. No.: 10/065,241

(22) Filed: Sep. 27, 2002

(51) Int. Cl. F16D 33/20

(52) U.S. Cl. 416/197 C

(57) ABSTRACT

An assembly for a fluid coupling that includes a hub having a body portion defining a central bore therethrough, with a radially extending flange extending from the body portion, and with the hub formed of a material that has a higher melting temperature than aluminum. A wheel having an outer shell portion is cast about the radially extending flange, and has an integrally cast set of blades, with the outer shell and blades made of aluminum. The assembly also includes a shroud mounted to the set of blades.

### BACKGROUND OF INVENTION

The present invention relates to torque converters and fluid couplings for use with vehicles.

In a vehicle drivetrain with an automatic transmission, a torque converter is mounted between the engine and the transmission. A torque converter turbine is splined to an input shaft of the transmission, and is mounted adjacent to a torque converter impeller, with fluid contained between the two. The impeller is driven off of an engine crankshaft and pumps the fluid which drives the turbine. The turbine typically includes a shell, blades (also called vanes), and a shroud, which direct the flow of fluid and hence cause the resulting driving of the transmission input shaft.

Conventional torque converter turbines are typically assembled from stamped pieces the turbine shell, shroud, and blades are stamped separately from one another. In order to join these three components structurally, the blades are formed with tabs on opposing edges, while the shell and shroud are formed with corresponding slots sized and spaced to receive the tabs. The tabs on a first edge are inserted into corresponding slots on the shell, and the shroud is then placed over the blades, aligned with the other set of tabs. These tabs are then bent or rolled over in order to lock the three pieces together into a single turbine wheel unit. To facilitate automatic blade assembly, clearance must be provided between the slots and tabs. The stamping and slotting processes are relatively expensive and take a long lead time due to the complicated die designs for the stamping and slotting. Furthermore, the assembly process for the blades to the shell and shroud requires relatively sophisticated equipment, which is very expensive. In addition, the hub must then be assembled to the turbine wheel, typically with rivets, which adds to the cost of assembly. The turbine wheel is then assembled to a hub member, typically by riveting the turbine wheel to a flange on the hub.

Moreover, this clearance between the slots in the shell and the tabs provides a potential leak path for the fluid to leak out of the shell. There are also potential leak paths between the edges of the blades and the adjacent surfaces of the shell or shroud, allowing fluid to flow along the surfaces of the shell or shroud rather than being directed in the desired flow path. Both types of leakage can cause a substantial performance, operating efficiency, and fuel economy penalty. Further, the three stamped parts are all typically made of steel, which is heavy, leading to a high rotational moment of inertia, thus reducing the performance of the torque converter. In addition, since these three parts are stamped, there is an inability to provide leading and trailing blade edges with the desired radii and to vary the thickness of the blades significantly, which effectively limits the choice of air foil shapes, hence limiting efficiency.

Torque converter turbines molded of plastic address many of the aforementioned limitations of stamped steel torque converter turbines. Consequently, more recent turbine designs have employed plastics. These designs tend to reduce the weight of the turbine, thus reducing the rotational moment of inertia. A turbine wheel formed of a one piece shell and blades also eliminates the need for slots through the shell because they are molded integrally. This also eliminates the gap between the shell and blades, offering potential for significant improvement in fuel economy by eliminating the leak paths. Also, the molded blades can have much more complex shapes, allowing for more efficient flow paths for the fluid.

On the other hand, it is difficult to assure that plastics will have adequate strength and retain the fatigue characteristics needed for a component that handles large loads and vibrations over a very broad range of operating temperatures. The interior of a torque converter is a harsh environment the turbine is subjected to high levels of axial directed loads, torsion, radially directed centrifugal forces, and thermally induced loads resulting from being subjected to high operating temperatures. Loads carried by the turbine wheel are transmitted to an input shaft of the transmission through a splined connection. The turbine wheel and hub must be able to withstand these high torsional and axial loads at elevated temperatures without cracking or separating. Plastics are generally unsuitable for this type of loading condition, so plastic molded turbines typically have been provided with a steel hub having splines for engaging the transmission input element. However, the harshness of the environment within the torque converter has made the joining of the steel hub with the rest of the plastic turbine difficult. The different coefficients of thermal expansion of the steel and the plastic tend to stress the joint, making it difficult to sustain the high axial and torsional loads to which the turbine is subjected. Moreover, a lost core process is generally required for forming the plastic. This process, while sufficient for low volume production, is not suitable for mass production of torque converter turbines. In addition, the cost of a plastic that is suitable for the harsh environment of a torque converter is very high relative to a metal, such as aluminum.

Thus, it is desirable to have a turbine assembly for a torque converter that overcomes the drawbacks of the conventional stamped steel and the more recent plastic turbine assemblies.

### SUMMARY OF INVENTION

In its embodiments, the present invention contemplates an assembly for a fluid coupling that includes a hub having a body portion defining a central bore therethrough, with a radially extending flange extending from the body portion, and with the hub formed of a material that has a higher melting temperature than aluminum. A wheel having an outer shell portion is cast about the radially extending flange, and has an integrally cast set of blades, with the outer shell and blades made of aluminum. The assembly also includes a shroud mounted to the set of blades.

An advantage of the present invention is that an aluminum turbine wheel insert molded over a hub can better handle the various high loading conditions, over the broad range of operating temperatures, than a plastic turbine wheel molded to hub. Also, the shroud can be formed separately and attached after casting, rather than being molded to the blades, allowing for more flexibility in shaping the blades as desired without the shroud creating difficulties with the designs of the molding/casting dies. Further, the aluminum turbine wheel will generally still have a lower rotational moment of inertia than a conventional steel turbine wheel.

An additional advantage of the present invention is that potential leak paths out of the turbine shell as well as between the turbine blades and the shell and shroud have been eliminated.

Another advantage of the present invention is that the assembly time is reduced, with fewer separate parts to assemble and an assembly that lends itself to a less complex automated assembly process, than with a conventional stamped steel turbine assembly. Further, no separate rivets or other fasteners are required during the assembly process.

A further advantage of the present invention is that tooling and die investments for forming the turbine cost much less, with a reduced lead time from design to producing production assemblies.

Another advantage of the present invention is that the die-casting process allows for the use of various hydrofoil/airfoil shapes for the blades, including both axially draftable and helically draftable blade shapes, thus assuring an efficiently operating torque converter.

Thus, the turbine assembly of the present invention provides advantages similar to a plastic torque converter turbine, but with the better strength and thermal characteristics of a stamped steel turbine assembly and with much less cost.

### BRIEF DESCRIPTION OF DRAWINGS

FIG. 1 is a perspective view of a front of a turbine assembly in accordance with the present invention;

FIG. 2 is a perspective view of the turbine assembly of FIG. 1, but showing the back side of the assembly;

FIG. 3 is a section cut through a portion of the assembly illustrated in FIG. 1;

FIG. 4 is a front view of the turbine wheel assembly of FIG. 1, but prior to attachment of a shroud;

FIG. 5 is a front view of a hub; and

FIG. 6 is a section cut of the hub, taken along line 6-6 in FIG. 5.

### DETAILED DESCRIPTION

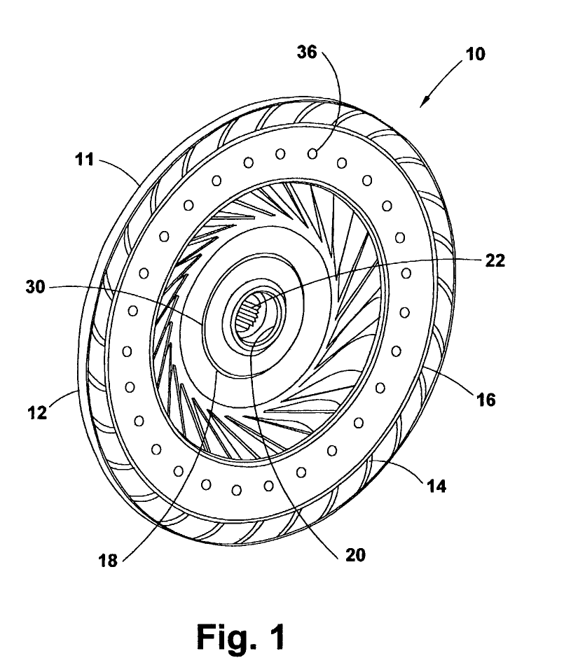

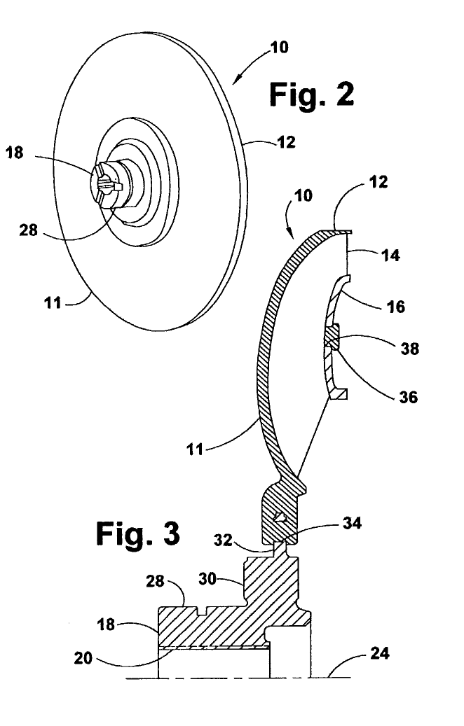

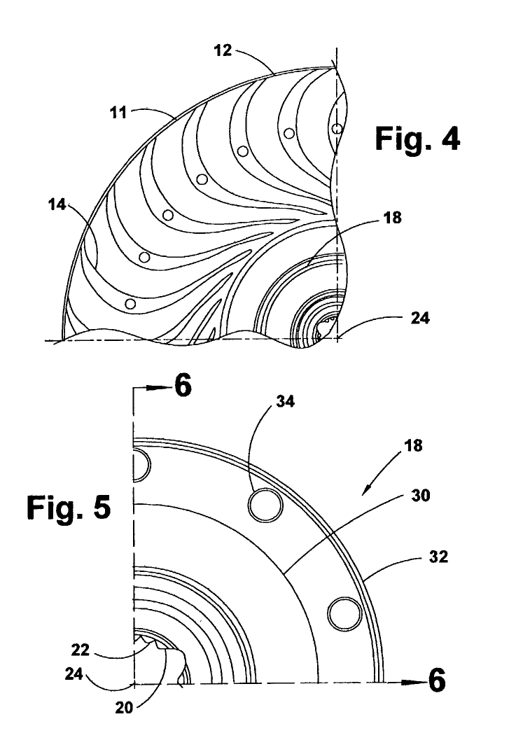

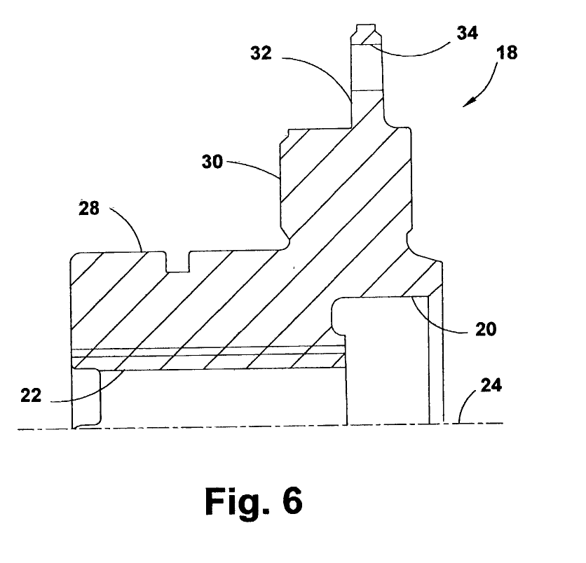

FIGS. 1-6 illustrate a turbine assembly 10 for use in a torque converter assembly in a vehicle. The turbine assembly 10 includes turbine wheel 11 that has an outer shell 12, with blades 14 extending therefrom, and a shroud 16 mounted on the blades 14. The outer shell 12 mounts about a hub 18, forming the complete turbine assembly 10. The hub 18 includes a bore 20, centered about a central longitudinal axis 24, with splines 22 formed on its surface that are designed to mount around the input shaft of a transmission (not shown) in a conventional fashion.

The fabrication and assembly of the turbine assembly 10 will now be discussed. The hub 18 is formed separately in a conventional fashion. It is preferably made of, for example, steel, sintered (powdered) metal, or some other material with similar strength properties that has a melting point higher than aluminum. The hub 18 is includes the bore 20, as noted above, formed within a main body portion 28. A shoulder portion 30 radially extends from the body 28, with a support flange 32 radially extending from the shoulder 30. The support flange 32 includes casting holes 34, spaced angularly about the flange 32. The support flange 32 provides support to the outer shell 12 and load transfer from the outer shell 12 to the hub 18, with the casting holes 34 causing the outer shell 12 to mechanically engage the hub 18, thus fixing the position of the outer shell 12 relative to the hub 18 and providing a means for better transferring torque between the outer shell 12 and hub 18 without the need for any separate fasteners.

The hub 18 is placed in a die casting mold (not shown), and is now ready for an insert molding process. Since this is a casting process, the casting dies can be fabricated to allow the formation of the desired blade shapes, without the limitations that are inherent in stamped blades. For example, while axially draftable (also called axial pull) blades are preferred when employing this manufacturing process since they generally are less expensive to fabricate using this process and they will result in a simplified die design this process is also applicable to helically draftable (also called radial pull) blades.

Molten aluminum is injected into the mold in a conventional die casting process. The die casting process is conventional in nature, and so the details of it will not be discussed further herein. The aluminum, then, will be cast around and bond to the support flange 32 as the molten aluminum flows around the surface of the flange 32. The aluminum will also flow into the casting holes 34 in the flange 32. When finished, an aluminum shell 12, blades 14 and, preferably, rivet pins 36 will be formed molded integrally to the hub 18. The rivet pins 36 are cast-in, pin-shaped protrusions that extend outward from the blades 14.

The shroud 16 is formed separately and can be formed in a conventional manner, such as, for example, stamping. It will be formed with holes 38 that line up with the rivet pins 36. The shroud is preferably formed of aluminum, in order to reduce weight and maintain the same thermal coefficient of expansion as the blades 14, but, if preferred, can also be formed of steel or other suitable material. The shroud 16 is assembled to the blades, and then the heads of the pins 36 are formed over the holes 38, so they act like rivets retaining the shroud 16. The forming of the pins 36 is preferably accomplished by orbital forming, although other methods of forming may be used instead. The assembly of the shroud 16 onto the pins 36 is a relatively simple process, that allows for easy automation, thus reducing the assembly costs for the turbine assembly 10. The completed turbine assembly 10 can now be assembled into a torque converter assembly in a conventional fashion.

While certain embodiments of the present invention have been described in detail, those familiar with the art to which this invention relates will recognize various alternative designs and embodiments for practicing the invention as defined by the following claims.

1. An assembly for a fluid coupling comprising:
a hub having a body portion defining a central bore therethrough, with a radially extending flange extending from the body portion, and with the hub formed of a material that has a higher melting temperature than aluminum;
a wheel having an outer shell portion cast about the radially extending flange, and an integrally cast set of blades, with the outer shell and blades made of aluminum; and
a shroud mounted to the set of blades.

2. The assembly of claim 1 wherein the wheel further includes a plurality of cast pins integral with and extending from the set of blades, and wherein the shroud includes a plurality of holes, with the holes sized and spaced to each receive a corresponding one of the pins.

3. The assembly of claim 2 wherein the flange includes a plurality of holes therethrough.

4. The assembly of claim 3 wherein the hub is made of powdered metal.

5. The assembly of claim 3 wherein the hub is made of steel.

6. The assembly of claim 1 wherein the hub includes a shoulder between the body portion and the flange.

7. The assembly of claim 1 wherein the wheel is a turbine wheel adapted for use in a torque converter.

8. The assembly of claim 1 wherein the flange includes a plurality of holes therethrough.

9. The assembly of claim 1 wherein the hub is made of powdered metal.

10. The assembly of claim 1 wherein the hub is made of steel.

11. A turbine assembly for use in a vehicle torque converter comprising:
a hub having a body portion defining a central bore therethrough, with a radially extending flange extending from the body portion, and with the hub formed of a material that has a higher melting temperature than aluminum;
a turbine wheel having an outer shell portion cast about the radially extending flange, an integrally cast set of blades, and a plurality of integrally cast pins extending from the blades, with the outer shell, blades, and pins made of aluminum; and
a shroud, including a plurality of holes sized and spaced to each receive a corresponding one of the pins, mounted to the set of blades.

12. The assembly of claim 11 wherein the flange includes a plurality of holes therethrough.

13. The assembly of claim 11 wherein the hub is made of steel.

14. A turbine assembly for use in a vehicle torque converter comprising:
a hub having a body portion defining a central bore therethrough, with a radially extending flange extending from the body portion that includes a plurality of holes therethrough, and with the hub formed of a material that has a higher melting temperature than aluminum;
a wheel having an outer shell portion cast about the radially extending flange, and an integrally cast set of blades, with the outer shell and blades made of aluminum; and
a shroud mounted to the set of blades.

15. The assembly of claim 14 wherein the hub includes a shoulder between the body portion and the flange.

16. The assembly of claim 14 wherein the wheel further includes a plurality of cast pins integral with and extending from the set of blades, and wherein the shroud includes a plurality of holes, with the holes sized and spaced to each receive a corresponding one of the pins.

17. The assembly of claim 16 wherein each of the pins has a head portion and wherein each head portion is formed over a corresponding one of the holes in the shroud by orbital forming.

18. The assembly of claim 14 wherein the hub is made of powdered metal.

19. The assembly of claim 14 wherein the hub is made of steel.

20. The assembly of claim 14 wherein the shroud is formed by stamping.
